(19) United States
(12) Patent Application Publication
(10) Pub. No.: US 2022/0163256 A1
(43) Pub. Date: May 26, 2022

(54) Storage System

(71) Applicant: Thalis NICOLAOU, Nicosia (CY)

(72) Inventor: Thalis NICOLAOU, Nicosia (CY)

(21) Appl. No.: 17/442,082

(22) PCT Filed: Mar. 20, 2020
(86) PCT No.: PCT/EP2020/057826

§ 371 Date: Sep. 22, 2021

(30) Foreign Application Priority Data
Mar. 22, 2019 (GB) 1903961.9

(51) Int. Cl. F25D 25/02

(52) U.S. Cl. CPC F25D 25/024; F25D 2325/021

(57) ABSTRACT

Moveable goods supporting arrangement for a storage unit and a method of using such arrangement. A guide mechanism comprises a first part and a second, extendable part and first connecting means for rotational connection of the linear guide mechanism to the storage unit. Second connecting means rotationally connect first ends of first and second divider parts, third connecting means rotationally connect a second end of the first divider part to the second, extendable part of the of the guide mechanism, and fourth connecting means rotationally connect a second end of the second divider part to the first part of the guide mechanism. Movement extending the guide mechanism moves the second ends of the first and second divider parts away from each other to enable access to a second storage area. Rotation of the guide mechanism relative to the storage unit enables access to a third storage area.

This disclosure generally relates to storage systems. More particularly, storage systems wherein goods can be placed on a support arrangement comprising a mechanism facilitating movement of the goods in and out a storage unit are disclosed.

Storage units providing closed storage volumes for storing a variety of goods are known. The goods can be any products or objects that a user may wish to put away in a storage unit either for long term or only temporarily. Variety of different storage units for different purposes are known. Non-limiting examples of storage units include kitchen cupboards, fridges, freezers, wardrobes, cabinets, drying cabinets, industrial storage units and so forth.

Goods can be placed in a storage unit on supporting holders such as shelves, trays, casings, baskets or the like. These in turn can be moveably supported so that accessibility to the goods is made easier and/or storage space used more efficiently. For example, a tray or basket can be attached to a door of a storage unit, or supported on rails or wheels so that is can be pulled out from the storage unit.

Storage area of a storage unit is defined by the walls. Thus the storage capacity is defined by the size of the walls. The depth a storage unit depends on the width of the side walls. The larger the depth, the greater the volume of the storage unit allowing storage of more goods. This can however cause a reachability problem. A problem with the depth can also be that goods in the back may become hidden by goods in the front. This can considerably reduce visibility and accessibility of stored products. This can result in issues such as reducing the overall visibility of stored goods which in turn can make the user unaware of what is stored in the unit. Goods may become “forgotten” in the storage, sometimes for long periods of time. Various goods, for example food items, can have a limited lifetime, and may be spoiled and wasted as a result.

Reduced accessibility can make the task of checking and/or reaching goods a more demanding task. For example, to reach at goods placed in the back the goods at the front may need to be removed first, identify the desired goods from the back, reach for it, remove and possibly place it back and relocate the front ones. A storage unit may also have large open volumes without being divided into sections. This can demotivate users from staying organised. When not organised, it is less likely for a user to remember what he/she has stored in a storage unit.

The herein described examples aim to address one or more of these issues.

According to an aspect there is provided a moveable goods supporting arrangement for a storage unit, comprising a guide mechanism comprising a first part and a second, extendable part, first connecting means for rotational connection of the linear guide mechanism to the storage unit, a goods supporting element comprising a first divider part and a second divider part, the first and second divider parts being spaced from each other such that a first storage area, a second storage area and a third storage area are defined by the first and second divider parts, second connecting means for rotational connection of first ends of the first and second divider parts, third connecting means for rotational connection of a second end of the first divider part to the second, extendable part of the of the guide mechanism, and fourth connecting means for rotational connection of a second end of the second divider part to the first part of the guide mechanism, wherein movement extending the guide mechanism is arranged to move the second ends of the first and second divider parts away from each other to reduce the width of the goods supporting arrangement and to enable access to the second storage area, and rotation of the guide mechanism relative to the storage unit is arranged to enable access to the third storage area.

According to another aspect there is provided a method for moving goods on a moveable supporting arrangement out of a storage unit, the method comprising pulling the supporting arrangement out from the storage unit, wherein the pull extends a guide mechanism and causes rotation of two divider parts of the supporting mechanism relative to each other and the guide mechanism such that the ends of the divider parts closer to the guide mechanism move away from each other and the width of the goods supporting arrangement reduces, the first divider part being brought out of the storage unit and the second storage area being made accessible, and rotating the guide mechanism relative to the storage unit to bring the second divider part out of the storage unit to make the third storage area accessible.

According to a more detailed aspect the fourth connecting means are arranged to rotate about the first connection means along an arc defined by the distance between the first and fourth connection means.

The divider parts may comprise substantially vertical elements arranged to rotate in a substantially horizontal plane. At least one of the divider parts may be substantially L-shaped.

The second connecting means may comprise flexible material for enabling rotational connection between the first divider part and the second divider part.

The first and second storage areas are connected to the first divider part and at least the third storage area is connected to the second divider part. At least the first storage area may be connected to the first divider part and the second and third storage areas may be connected to the second divider part.

The first connecting means may connect the first part of the guide mechanism with the storage unit close to location where the second, extendable part of the guide mechanism joins the first part.

At least one of the first, second, third and fourth connecting means may comprise a pivot. The guide mechanisms may be configured for linear and/or curved movement of the second end of the first divider part. The second, extendable part of the guide mechanism may be arranged in sliding engagement with the first part of the guide mechanism.

Additional means for supporting the goods supporting element may be provided. The means for supporting the goods supporting element may comprise a linkage mechanism at the top of the support element for providing support during movement of the support element relative to the storage unit. One part of the linkage mechanism may be attached to a bar connecting rotation axes of the first and the fourth connecting means. Another part of the linkage mechanism may be attached to the storage unit. A support element located at or close to the second connecting means may also be provided. The support means may comprise a wheel or a slider arranged to move on a bottom part of the storage unit. The support means may also comprise a hanging support mechanisms configured to move substantially following an arc defined by movement of the guide mechanism.

At least one of the divider parts can be arranged for removable support of different types of goods carrying elements. The goods carrying elements may comprise at least one of a tray, a case, a basket, a shelf, a hook and/or a box.

A divider part may comprise at least one of rails, grooves, apertures, hook and loop connectors, and magnets for holding goods carrying elements in place in the respective storage areas.

At least one further divider part may be provided. At least one further storage area may be provided.

According to a further aspect a food storage unit comprising a moveable goods supporting arrangement as described herein is provided. A food storage unit may comprises a fridge and/or a freezer.

The invention will become more fully understood from the detailed description of certain examples and the accompanying drawings, in which:

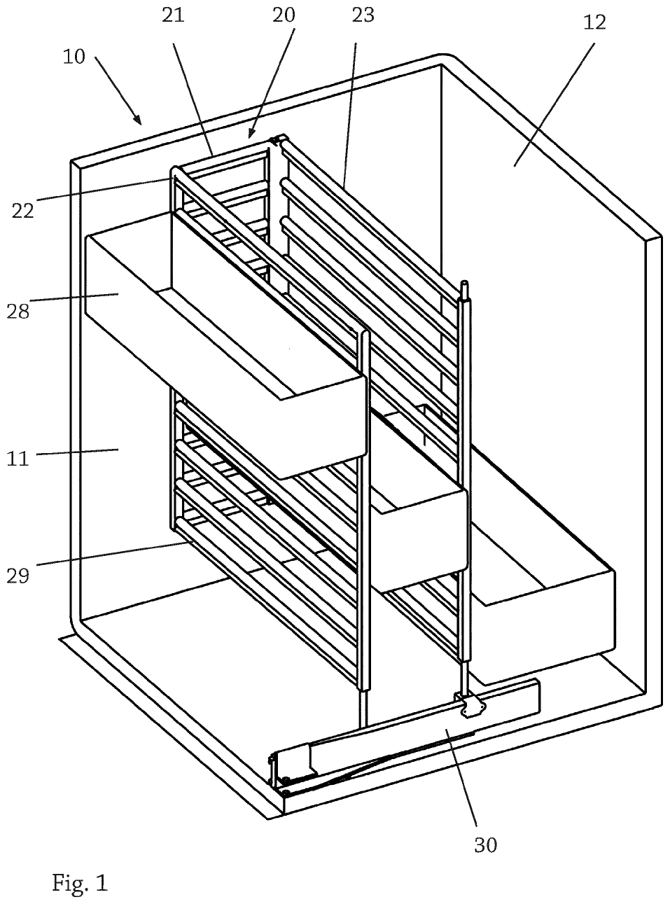

FIG. 1 is a perspective and partially sectioned view of a storage unit;

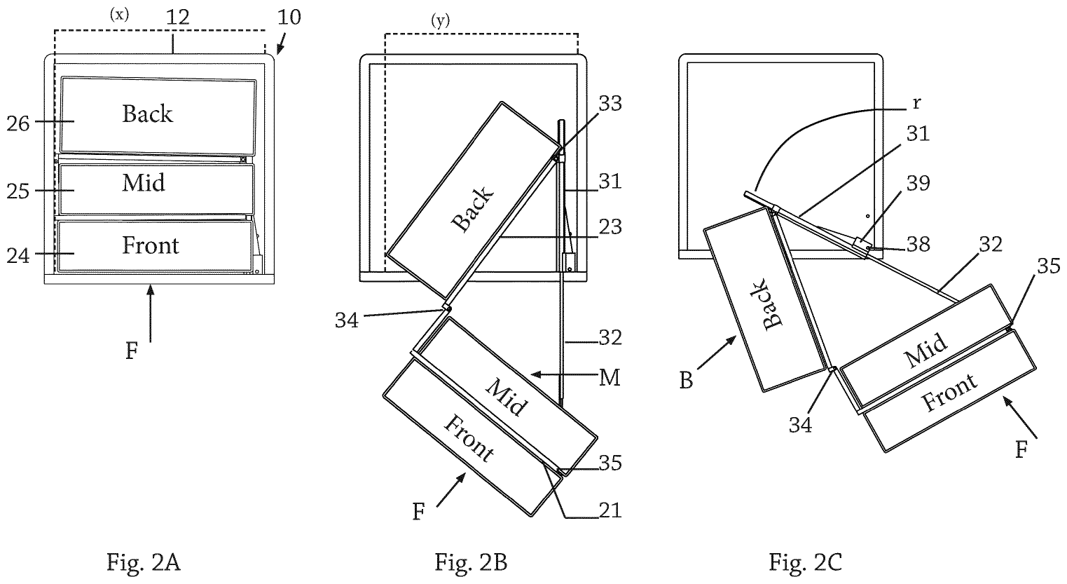

FIGS. 2A, 2B and 2C show top views of an exemplifying support system in three operational positions;

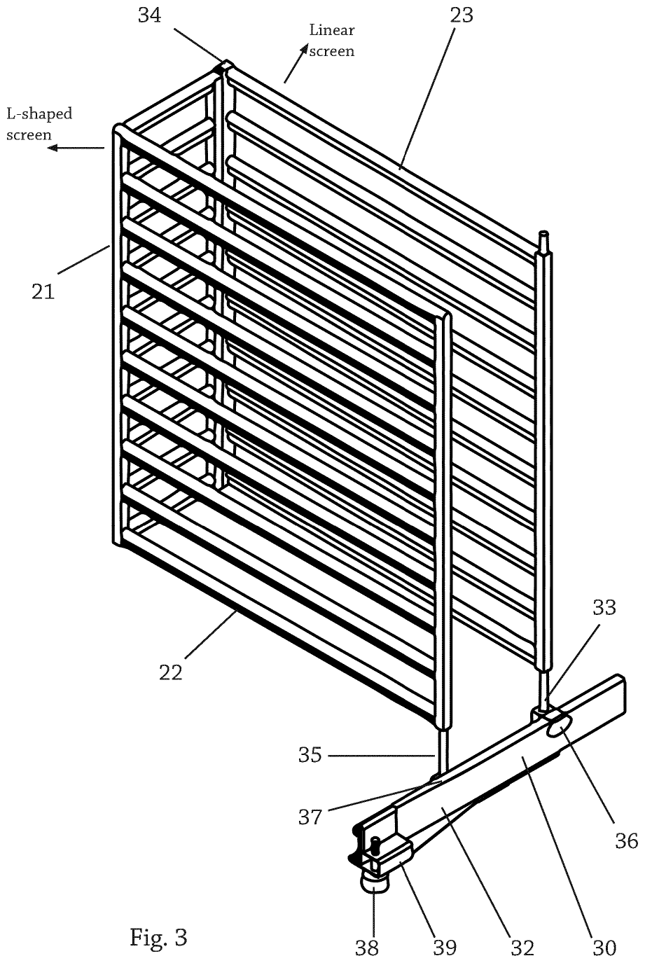

FIG. 3 is a perspective view of certain elements of the disclosed storage system;

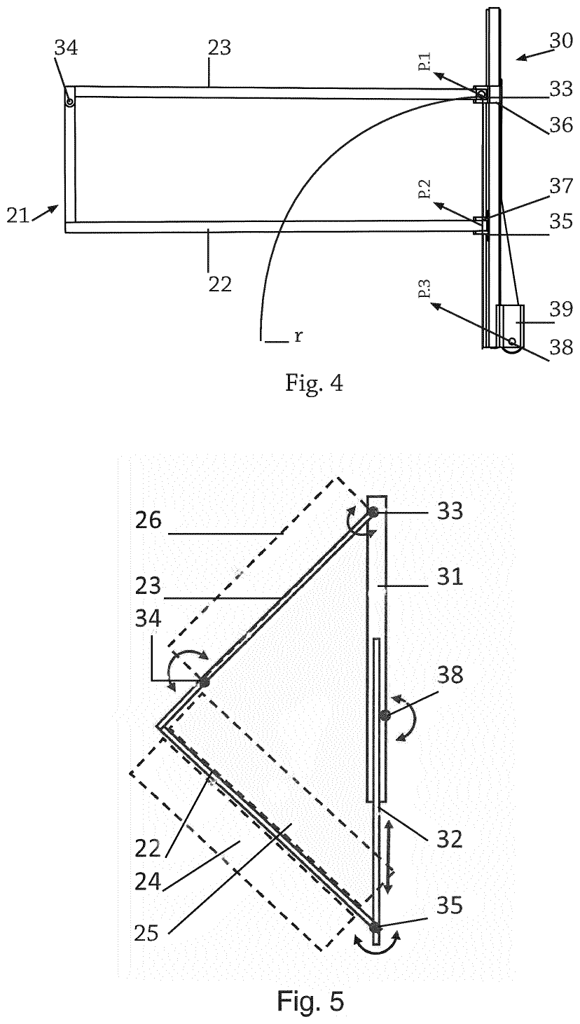

FIG. 4 is a top view illustrating pivot points of the system;

FIG. 5 is a schematic presentation of linear and rotational movements;

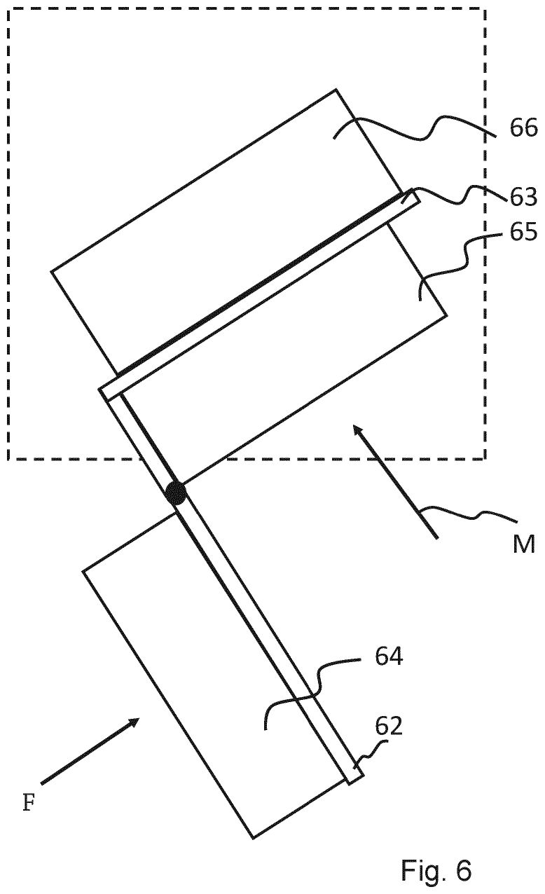

FIG. 6 shows another arrangement of storage areas;

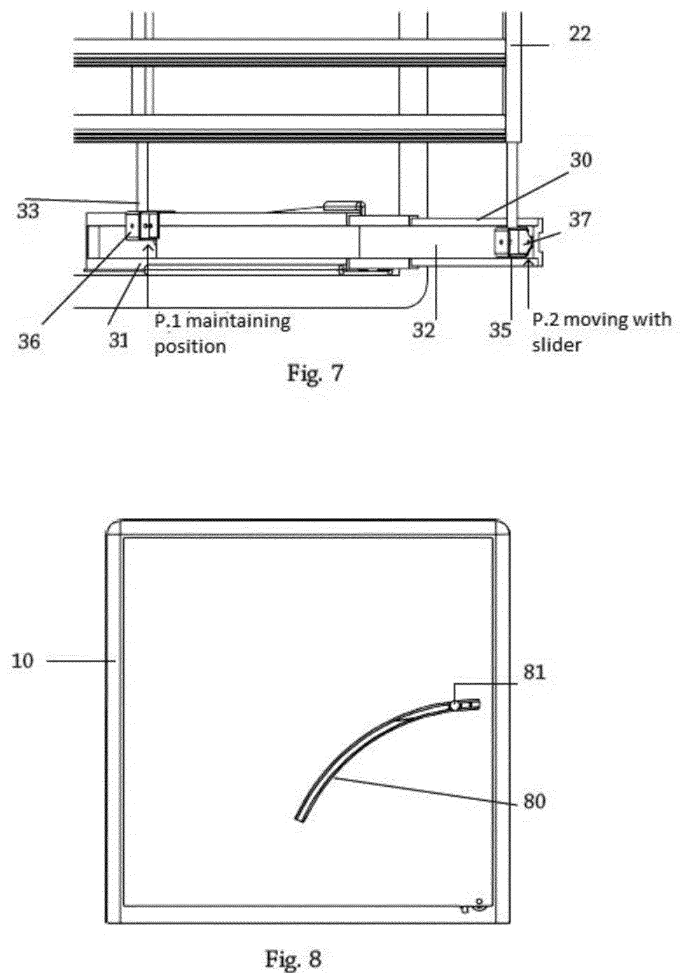

FIG. 7 is a side view of pivot points of FIG. 4;

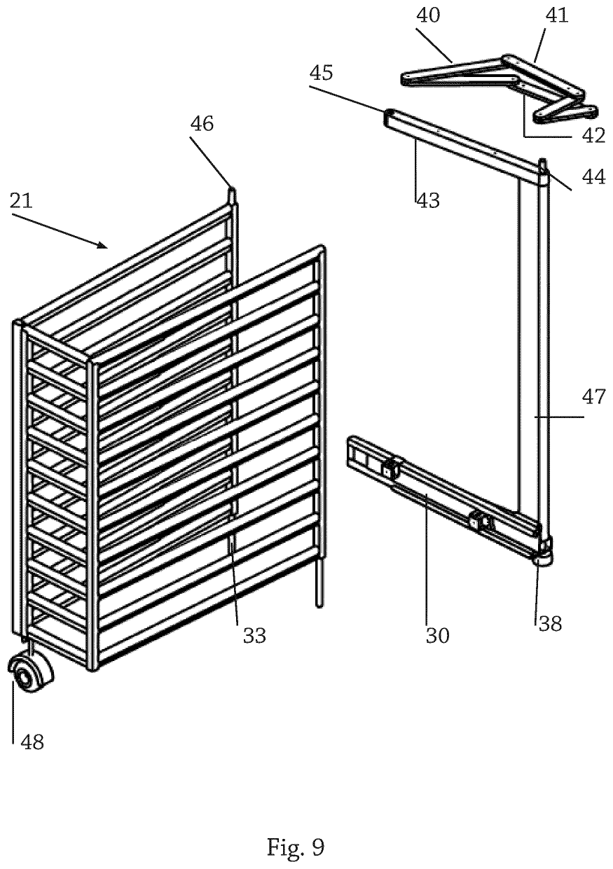

FIGS. 8, 9, 10A, 10B, and 10C show examples of additional support mechanisms;

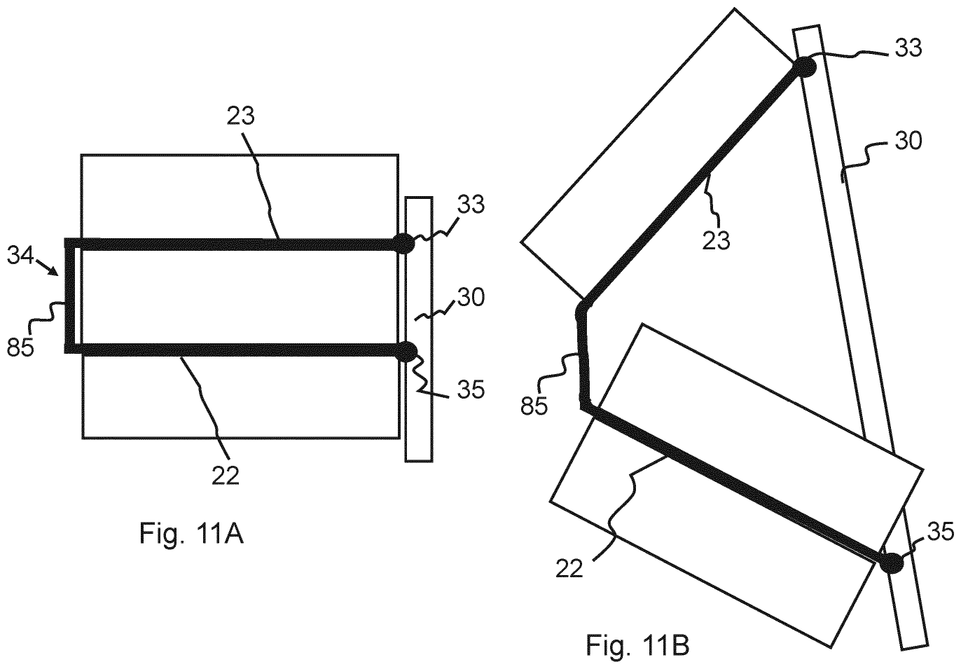

FIGS. 11A and 11B show a further example of arranging rotation between elements;

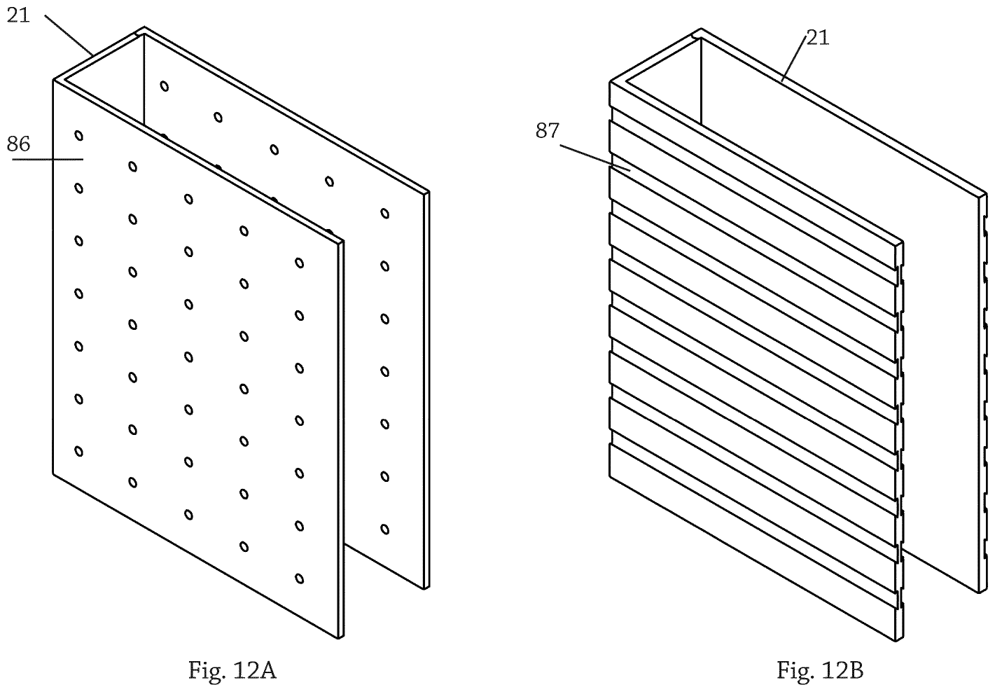

FIGS. 12A and 12B show further examples of goods supporting elements;

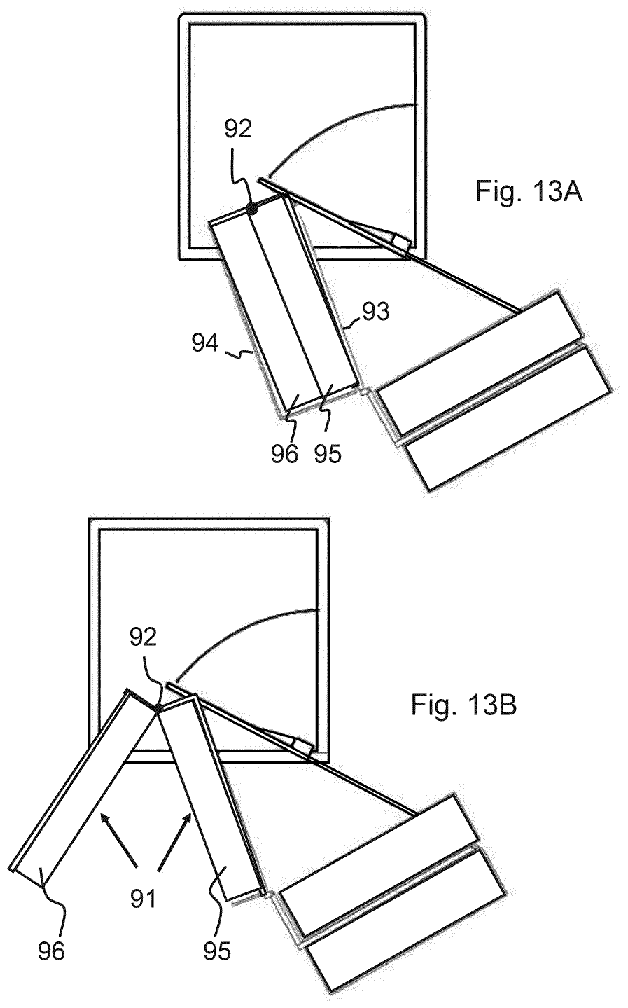

FIGS. 13A and 13B shown a further example of a storage system;

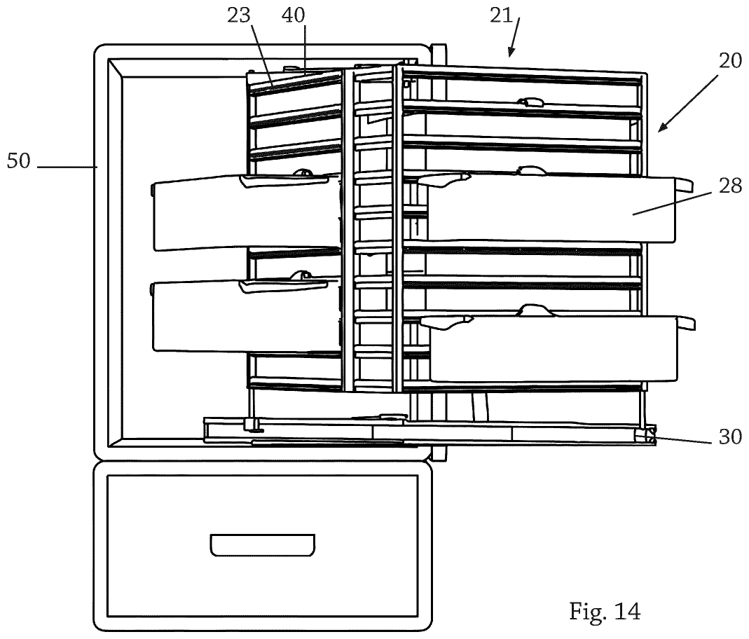

FIG. 14 is an example where the storage system is installed in a fridge; and

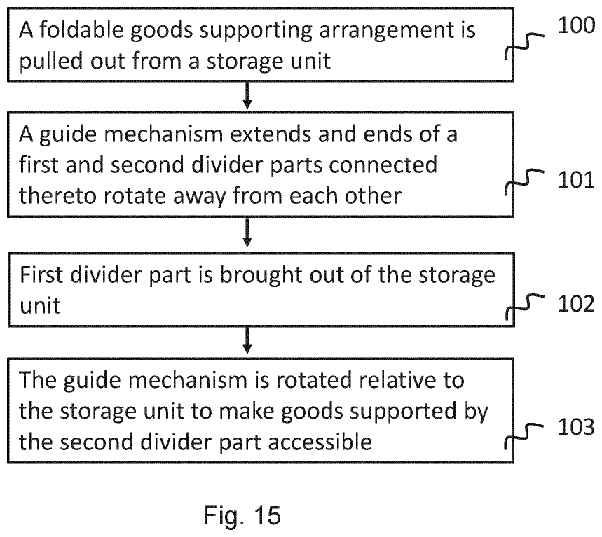

FIG. 15 is a flow chart outlining steps of a method according to an example.

The following describes with reference to the appended drawings certain detailed examples for storage systems that can be assembled into a storage unit. A storage unit with a built-in storage system is also described. The herein described principles and features can increase visibility, accessibility and/or organisation of goods placed in the storage unit. This is achieved by dividing the depth of the internal space into separate storage sections and by use of a mechanism that can be used to move the storage sections to more accessible positions and back into the storage unit.

FIG. 1 shows a perspective view of a storage unit 10 where one of the side walls is removed for illustration purposes to expose components of the storage system. The internal volume of the storage unit is defined by the height and width of a back wall 12, side walls 11 (only one shown) and front part. The front part of the unit may be closed by a door. Inside the storage unit is a moveable storage system 20 for supporting goods placed in the unit.

The storage system 20 of the example is arranged to provide three separate storage sections or areas 24, 25 and 26. The storage sections are referred as front, mid and back sections. Positioning of these sections in various operational positions is shown by the top views of FIGS. 2A, 2B and 2C.

The storage system 20 comprises a holder member 21 for supporting goods in the unit and an unfolding guide mechanism 30. The storage system 20 is arranged to extend and rotate in a substantially horizontal plane in order to narrow the total width occupied by the storage system when it is moved and to bring the middle and back storage areas accessible to the user.

The holder member 21 comprises two dividers 22, 23 that separate the storage volume into three sections. The divider parts of the holder member can define how and where the goods are stored. The two dividers 22, 23 extend substantially vertically between the storage sections 24, 25 and 26. The dividers, referred also as screens in this description, of the example comprise an L shape divider element 22 and a linear or planar divider element 23. It is noted that differently shaped dividers may also be provided, For example, at least one of the dividers can be curved or S-shaped.

The holder member 21 may be supported on the guide mechanism 30 as will be described below. The guide mechanism 30 is fixed by a rotational mechanism relative to the storage unit 10. The attachment between the mechanism and the storage unit can be by any appropriate technique, for example screws, nail, adhesive, welding, and so on. The mechanism can be attached to the bottom, side walls or both of the storage unit.

A guide mechanism can also be placed at the top of storage unit, or close thereto. For example, a guide mechanism or part thereof can be fixed at the roof panel of the storage unit. A guide mechanism can also be provided both at the bottom part and the top part of the goods supporting element 21.

In the example of FIG. 1 storage trays 28 are shown hanging on rails 29 of the divider screens. It shall be appreciated that the trays are only shown as non-limiting examples of support members that can be used for placement of goods in the storage unit. Other types of support members can be provided. For example, one or several of the trays can be replaced by cases, boxes, baskets, shelves, hooks, rails and so on. A support arrangement can also comprise a mixture of different support members.

FIGS. 2A, 2B and 2C show the unfolding guide mechanism, the divider parts 22, 23 and the three storage sections 24, 25 and 26, in three different operational positions. The unfolding guide mechanism is configured for guiding the transformation of the holder member 21 between the different positions. The co-operation of the holder member and the unfolding mechanism results an arrangement capable of bringing the stored goods out from the storage unit into more accessible positions. The unfolding mechanism is shown to comprise an extendable slider guide where an extendable end part 32 thereof can slide out from a base part 31 so that the length of the slider guide can be extended as shown in FIGS. 2A to 2C.

In FIG. 2A the mechanism is in contracted state. Thus only the front section 24 is visible and accessible, as pointed by arrow F. As can be seen from FIG. 2A, the storage volume is substantially efficiently filled with the three storage areas 24, 25 and 26.

In FIG. 2B the mechanism is partially opened such that the midsection 25 is now accessible. The direction of access to the midsection according to this example is pointed by arrow M.

In FIG. 2C the mechanism is fully opened. The back storage section 26 is now accessible from the direction pointed by arrow B. As can be seen, even the back storage section 26 is brought substantially in its entirety out from the storage unit 10.

The mechanism is configured to move the holder member 21 such that the stored goods can be brought out from the storage unit 10. The mechanism does this by a combination of the extension slider 32, a pivot 39 and relative movement between the divider parts. The mechanism provides a combination of linear and circular motion to bring the stored products into an accessible position.

In FIG. 2A the extension slider 32 is in retracted position. When opening the mechanism, the extension slider first extends straight displacing the stored products to the position shown in FIG. 2B. In this position, the front and middle storage areas 24, 25 are brought out from the unit 10. Back storage area 26 has also been rotated although this area is not yet accessible.

The rotating of the sections 24, 25 and 26 relative to the slider guide mechanism 30 and other sections is arranged about pivot points 33, 34 and 35. Divider 23 can rotate about pivots 33 and 34, and divider 22 can rotate about pivots 34 and 35. This rotation reduces the total width of the storage system 20 from (x) of FIG. 2A to (y) of FIG. 2B as the system 20 is moved out from the storage unit. This reduction of width makes it possible for the back storage area 26 to freely rotate uninterrupted to the front of the storage unit, as shown in FIG. 2C. Thus all storage areas can be made accessible outside the storage unit 10 by a single task of unfolding the storage system 20 out from the storage unit.

In order to place the goods back into the unit, the same procedure takes place but in reverse. That is, the storage system can be pushed back so that the mechanism returns into the folded position of FIG. 2A. The unfolding mechanism firstly rotates and then retracts until the whole system is within the storage unit.

Arrangement of the exemplifying holder member comprising two planar divider elements or screens 22 and 23 that are rotational relative to the slider guide 30 is now explained further with reference to FIGS. 2, 3, 4 and 5. As shown, the divider part 23 can be substantially planar and divider part 22 can have L shaped form. The divider parts are held together at pivot point 34 at a corner between them to allow the screens to rotate relative to each other. The divider parts or screens are also connected pivotally to the slider guide, or more generally unfolding mechanism 30. To arrange this each screen is provided further with a connecting member 36, 37 that pivotally joins at 34, 35 the other ends of the screens to the slider guide 30. Connecting member 37 is arranged to be able to slide relative to the base element 31 of the slider guide 30 when the extendable element 32 moves in and out whereas pivotal connecting member 36 is fixed relative to the base element of slider guide 30.

The slider guide 30 in turn is pivotally connected at 38 to the storage unit 10 by a connecting member 39, shown in FIG. 3.

The desired displacement of the separate storage areas (Front, Mid, Back) leading to the reduction of the storage system's total width as shown in FIG. 2B is achieved because pivot point 35 moves with the extension slider 31 as it extends whilst pivot point 33 maintains its position, see FIG. 2C. Because of this the storage system's area stretches out which results to the reduction of its total width, leading to the uninterrupted motion of the back storage area 26 in FIG. 2C.

FIG. 4 illustrates the rotation axes. When the rotation of the slider guide 30 takes place about axis 38, the second divider 23 also rotates about axis 33 creating a path of an arc r with a radius defined by the distance between axes 33 and 38 FIG. 4. The rotation about axis 38 along the arc r has the effect of bringing the back storage area 26 to the front of the storage unit, increasing the visibility and accessibility thereof from the initial position.

FIG. 5 illustrates schematically a top view of axes or pivot points and linear and rotational movements of the system. As shown, the guide mechanism 30 comprises a first part 31 and a second, extendable part 32. As discussed above, the guide mechanism is connected by a first pivot 38 to a storage unit to enable the guide mechanism 30 rotate relative to the storage unit. The first pivot can be arranged to connect the first part of the guide mechanism with the storage unit close to location where the second, extendable part joins the first part.

The above discussed holder or support element 21 comprising a first divider part 22 and a second divider part 23 is arranged to have a second pivot 34 between the divider parts. The second pivot connects the first and the second divider parts from first ends thereof to enable rotational movement between the first and second divider parts.

The divider parts are spaced from each other such that a first storage area 24, a second storage area 25 and a third storage area 26 are defined by the two divider parts. According to the example of FIGS. 1 to 5 the first and second storage areas are connected to the first divider part and the third storage area is connected to the second divider part.

FIG. 6 shows an example of an alternative solution where an L-shaped divider part 63 is provided as the back, or second supporting divider. In this example a first storage area 64 is connected to a first divider part 62. Second and third storage areas 65, 66 are connected to the second divider part 63. The second storage area 65 can be accessed after the divider parts have been rotated open, as indicated by arrow M. Rotating the entire storage mechanism about the axis connecting the mechanisms to the storage unit then brings the third storage area 66 into an accessible position.

According to a further possibility the two dividers parts provide two storage areas each. For example, the first divider part can also be provided as an L-shaped element accommodating a second storage area on the inside thereof. According to another alternative the L-shape of the second divider part 63 is extended so that there is space for a storage area on the back of the first divider part.

A third pivot 35 is provided for connecting the second end of the first divider 22 to the second, extendable part 32 of the of the guide mechanism 30. A fourth pivot 33 is provided for connecting the second end of the second divider member 23 to the first part 31 of the guide mechanism. The arrangement is such that movement extending the guide mechanism 30 causes the two dividers 22, 23 rotate about the respective second, third and fourth pivots 34, 35, 33 and away from each other to reduce the width of the goods supporting arrangement. At the same time the first divider and the first and second storage areas 24, 25 are brought out of the storage unit. Subsequent rotation of the linear guide mechanism 30 about the first pivot 38 is arranged to bring the second divider 23 and the third storage area 26 out of the storage unit. The operation of the mechanism is thus a combination of a linear and circular motion with the entire storage system having a common axis of rotation.

FIG. 7 shows a side view of the pivot points of the example of FIGS. 1, 3 and 4 on the sliding guide mechanism 30. It shall be appreciated that FIG. 7 is only a non-limiting example of a bracket type pivoting arrangement and that other types of connection arrangements enabling rotation between the elements of the unfolding mechanism are also possible.

Additional means for supporting and/or guiding the goods supporting element may also be provided. FIG. 8 shows a top view of a storage unit 10 where a ball and socket type support and/guide arrangement 81 is provided for the moveable goods supporting element. The additional support means thus provide a hanging support mechanism configured to support and/or guide the moving support element from the top. The movement of the support element can be arranged along an arc 80 discussed with reference to FIG. 4. The movement path can also be arranged so that the follows the rotational movement of the guide mechanisms, e.g., closer to or farther away from the turning point 35. The support by element 81 can be provided substantially at the location of pivot point 33.

Guiding by the additional support means can also provide a stoppage of the movement of the mechanisms in one or both directions. For example, the arc 80 can be used to define how much the mechanism can be opened and how far it can be pushed back into the storage unit.

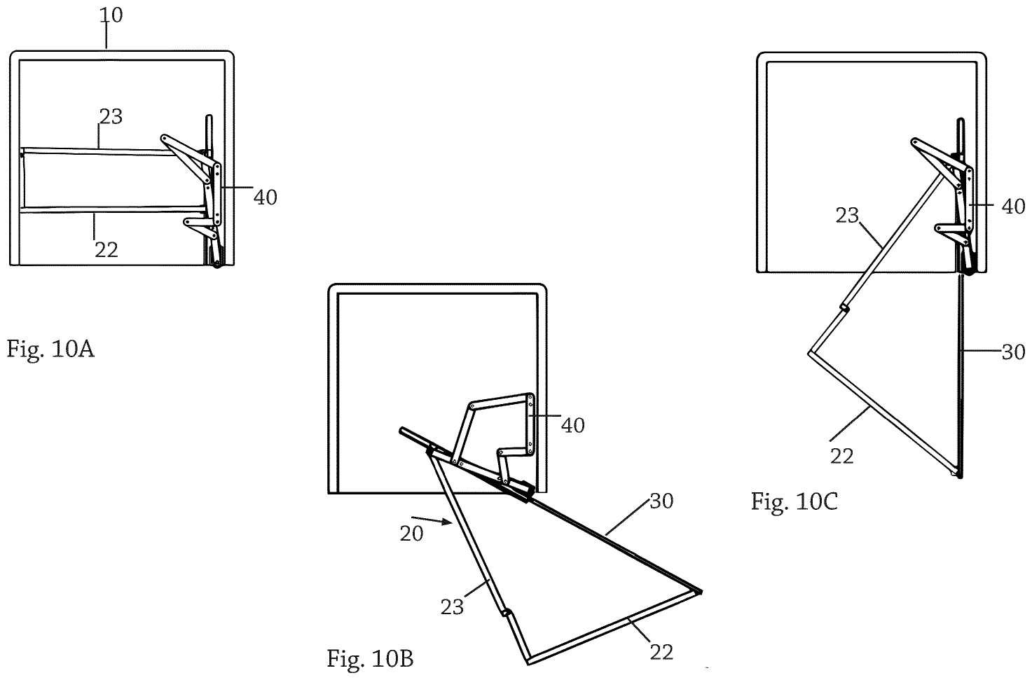

The means for supporting the goods supporting element may also comprise a linkage mechanism. An example of a linkage mechanism 40 is illustrated in the explosion FIG. 9. The linkage mechanism 40 may be provided above the foldable storage system to support and guide movement of the goods supporting holder member 21. A part 42 of the linkage mechanism is attached to a bar 43 connecting rotation axes 38 and 33 of the first and the second connecting means. Another part 41 of the linkage mechanism can be attached to the storage unit, for example at the ceiling panel thereof. FIGS. 10A, 10B, and 10C shows three operational positions of the linkage mechanism 40.

The extendable guide mechanism 30 and the bar 43 can the connected by a post 47. This can be provided to ensure that turning points 38 and 44 stay in line. Further, providing an element of parts 30, 47 and 53 of the mechanism as one assembly may ease installation of the mechanism into a storage unit. Diagonal support can be provided at the corners to improve the rigidness of the structure.

According to a further example a support element can be located at, or close to, the end of good supporting element 21, for example in the vicinity of the second rotation element connecting the two divider parts. FIG. 9 illustrates as an example a support wheel 40 arranged to roll on the floor of the storage unit. Other types of supports are also possible. For example, a slider can be arranged to move along a bottom part of the storage unit.

Rotation between elements can provided by various manners. According to a possibility shown in FIGS. 11A and 11B divider parts 22 and 23 and joined by flexible material 85. Rotation of divider parts 22 and 23 relative to each other at the first ends thereof can thus take because of the deformation of the flexible material at 34. Rotation at 33 and 35 may take place as described above. The divider parts and the connecting part can be provided from a single piece of deformable material. According to a possibility deformable material joins the divider parts together. Thus the divider parts may be provided such that the rotation between the divider parts is enabled by flexible material between the parts rather than about a pivot axis. The material can be selected such that it allows deformation about a point where the individual divider parts join.

According to a possibility, instead of having just one rotation point 34 at the far end of the goods supporting element, two rotation points can be provided. For example, rotation can be arranged at two corners of the goods supporting element 21 of FIG. 1, the element being constructed of two divider part pieces and an end piece.

The goods supporting holder element 21 defines how and where goods can be stored. The holder element, and more particularly the dividers or screens can be arranged as a modular or a fixed storage device. Modularity can be determined by the design of the screens.

In FIGS. 1, 3 and 9 the dividers of the good supporting element are shown to comprise horizontally extending rails on which good carrying elements such as trays, cases, shelves, boxes, hooks or the like can be hung. The positioning of the carriers can be changed by selecting another rail to hang. This allows adjustment of each case height and distance between carrier elements. The gaps between the levels and the screens allows air within the storage unit to circulate. Such railed arrangement can be used for example for a fridge or drying cabinet. This can be advantageous for example within a fridge, drying cabinet or the like unit where air circulation is desired.

Rails can be provided with a strip of material. The material may extend from one end of the rail to the other end. This material provides a source of friction in order to prevent cases from sliding/moving when the mechanism is in use. Other features that restrict the movement of the cases can be used. For example, the rails can be provided with teething, roughening and/or corrugation to prevent movement of the supported casings or other elements.

According to a possibility the rail like pattern does not continue all the way until the bottom surface of the storage unit. There can be a variety for reasons for this. Space may be left, e.g., to improve the circulation of air, to provide access to the user for tasks such as swiping the floor from dirt, collecting anything that might have fallen and so for.

Even though the above explains supporting, e.g., cases or any other carriers that support products, the storage arrangement can be used for other purposes as well where bringing all products to a visible and accessible position is desired. For example clothes, towels, bedsheets etc. could be hanged directly on the rails of the screens or on hooks placed on the rails.

FIGS. 12A and 12B show further examples for divider screens of a goods supporting holder member 21. The divider member may comprise, instead of, or in addition to rails, e.g., apertures 86 as shown in FIG. 12A or grooves 87 as shown in FIG. 12B. Co-operating members of carrier elements such as trays or the like can be placed in the apertures or grooves. Other solutions such as hook and loop connectors, magnets, snap fit connectors, screws, slots and the like, for holding goods supporting elements in place in the respective storage area may also be used.

FIGS. 13A and 13B show an example where a further, or fourth storage area 96 is provided in connection with a second screen 93. The second screen 93 is pivotally connected at 92 to a third screen 94 providing trays or the like storage elements. Storage areas 95 and 96 are brought out from the storage unit and accessible from the front as indicated by arrows 91.

FIG. 14 shows an example where the storage system 20 is assembled in a fridge 50. The assembly comprises an extendable guide mechanism 30 and linkage mechanism 40 for supporting a goods supporting element 21. As shown, all products in the fridge can be brought out by pulling divider parts 22 and 23 out from the fridge.

FIG. 15 shows a flowchart for a method for moving goods on a foldable goods supporting arrangement. The goods supporting arrangement can be pulled out from the storage unit at 100. The pull extends at 101 a guide mechanism and causes rotation of two divider parts relative to each other at one end so that the other end move away from each other and the divider parts open. At the same time the width of the goods supporting arrangement is reduced and the first divider member is brought out from the storage unit at 102. The guide mechanism is rotated at 103 relative to the storage unit to bring the second divider part out of the storage unit so that storage area(s) at the back become accessible.

The herein described system improves accessibility and visibility to goods in the storage and provides a system where all goods can be brought out of the storage unit. Because of this even the furthest away goods can be brought to an instantly accessible position. When the mechanism is completely unfolded, the area that is occupied by the parts out of the storage unit can be made to be less than the storage unit's depth. As a non-limiting example, when the storage system is used in a 60 cm×60 cm standard cupboard size all of the products will be out of the cupboard with a maximum forward displacement of 56 cm.

While certain aspects of the invention may be illustrated and described as schematic pictorial representation and flow charts, it is well understood that these blocks, systems, techniques and methods described herein may be implemented in various manners.

The foregoing description provides by way of exemplary and non-limiting examples a full and informative description of exemplary embodiments of the invention. Various modifications and adaptations may become apparent to those skilled in the relevant arts in view of the foregoing description, when read in conjunction with the accompanying drawings and the appended claims. All such and similar modifications of the teachings of this invention will still fall within the spirit and scope of this invention.

1. A moveable goods supporting arrangement for a storage unit, comprising:
a guide mechanism comprising a first part and a second, extendable part,
first connecting means for rotational connection of the linear guide mechanism to the storage unit,
a goods supporting element comprising a first divider part and a second divider part, the first and second divider parts being spaced from each other and separating the storage volume into sections such that a first storage area, a second storage area and a third storage area are defined by the first and second divider parts,
second connecting means for rotational connection of first ends of the first and second divider parts,
third connecting means for rotational connection of a second end of the first divider part to the second, extendable part of the of the guide mechanism, and
fourth connecting means for rotational connection of a second end of the second divider part to the first part of the guide mechanism,
wherein movement extending the guide mechanism is arranged to move the second ends of the first and second divider parts away from each other to reduce the width of the goods supporting arrangement and to enable access to the second storage area, and rotation of the guide mechanism relative to the storage unit is arranged to enable access to the third storage area.

2. A moveable goods supporting arrangement according to claim 1, wherein the fourth connecting means are arranged to rotate about the first connection means along an arc defined by the distance between the first and fourth connection means.

3. A moveable goods supporting arrangement according to claim 1, wherein the divider parts comprise substantially vertical elements arranged to rotate in a substantially horizontal plane.

4. A moveable goods supporting arrangement according to claim 1, wherein at least one of the divider parts is substantially L-shaped.

5. A moveable goods supporting arrangement according to claim 1, wherein
the second connecting means comprise flexible material for enabling rotational connection between the first divider part and the second divider part.

6. A moveable goods supporting arrangement according to claim 1, wherein the first and second storage areas are connected to the first divider part and at least the third storage area is connected to the second divider part, or wherein at least the first storage area is connected to the first divider part and the second and third storage areas are connected to the second divider part.

7. (canceled)

8. A moveable goods supporting arrangement according to claim 1, wherein the first connecting means connects the first part of the guide mechanism with the storage unit close to location where the second, extendable part of the guide mechanism joins the first part of the guide mechanism.

9. A moveable goods supporting arrangement according to claim 1, wherein at least one of the first, second, third and fourth connecting means comprises a pivot, and/or the guide mechanisms is configured for linear and/or curved movement of the second end of the first divider part and/or the second, extendable part of the guide mechanism is arranged in sliding engagement with the first part of the guide mechanism.

10. (canceled)

11. (canceled)

12. A moveable goods supporting arrangement according to claim 1, comprising means for supporting the goods supporting element.

13. A moveable goods supporting arrangement according to claim 12, wherein the means for supporting the goods supporting element comprise a linkage mechanism at the top of the support element for providing support during movement of the support element relative to the storage unit.

14. A moveable goods supporting arrangement according to claim 13, wherein one part of the linkage mechanism is attached to a bar connecting rotation axes of the first and the fourth connecting means and another part of the linkage mechanism is attached to the storage unit.

15. A moveable goods supporting arrangement according to claim 14, comprising a post for rigidly connecting the bar and the guide mechanism.

16. A moveable goods supporting arrangement according to claim 12, comprising a support element located at or close to the second connecting means.

17. A moveable goods supporting arrangement according to claim 12, wherein the support means comprises a wheel or a slider arranged to move on a bottom part of the storage unit and/or the support means comprises a hanging support mechanisms configured to move substantially along an arc defined by movement of the guide mechanism.

18. (canceled)

19. A moveable goods supporting arrangement according to claim 1, wherein at least one of the divider parts is arranged to removably support different types of goods carrying elements.

20. A moveable goods supporting arrangement according to claim 19, wherein the goods carrying elements comprise at least one of a tray, a case, a basket, a shelf, a hook and/or a box and/or wherein the divider part comprises at least one of rails, grooves, apertures, hook and loop connectors, and magnets for holding goods carrying elements in place in the respective storage area.

21. (canceled)

22. A moveable goods supporting arrangement according to claim 1, comprising at least one further divider part arranged to provide at least one further storage area.

23. A storage unit comprising a moveable goods supporting arrangement comprising:
a guide mechanism comprising a first part and a second, extendable part,
first connecting means for rotational connection of the linear guide mechanism to the storage unit,
a goods supporting element comprising a first divider part and a second divider part, the first and second divider parts being spaced from each other and separating the storage volume into sections such that a first storage area, a second storage area and a third storage area are defined by the first and second divider parts,
second connecting means for rotational connection of first ends of the first and second divider parts,
third connecting means for rotational connection of a second end of the first divider part to the second, extendable part of the guide mechanism, and
fourth connecting means for rotational connection of a second end of the second divider part to the first part of the guide mechanism,
wherein movement extending the guide mechanism is arranged to move the second ends of the first and second divider parts away from each other to reduce the width of the goods supporting arrangement and to enable access to the second storage area, and rotation of the guide mechanism relative to the storage unit is arranged to enable access to the third storage area.

24. A storage unit according to claim 23, comprising a fridge and/or a freezer.

25. A method for moving goods on a moveable supporting arrangement out of a storage unit, wherein a first divider part and a second divider part separate the storage volume of the storage unit into sections such that a first storage area, a second storage area and a third storage area are defined by the first and second divider parts, the method comprising:
pulling the supporting arrangement out from the storage unit, wherein the pull extends a guide mechanism and causes rotation of the two divider parts relative to each other and the guide mechanism such that the ends of the divider parts closer to the guide mechanism move away from each other and the width of the goods supporting arrangement reduces and the first divider part is brought out of the storage unit and the second storage area is made accessible, and
rotating the guide mechanism relative to the storage unit to bring the second divider part out of the storage unit to make the third storage area accessible.
